(19) United States
(12) Patent Application Publication
(10) Pub. No.: US 2019/0260250 A1
(43) Pub. Date: Aug. 22, 2019

(54) STATOR OF ELECTRIC ROTARY MACHINE

(71) Applicant: HONDA MOTOR CO., LTD., Tokyo (JP)

(72) Inventors: Tomotaka IKI, Saitama (JP); Fumiya NISHII, Saitama (JP); Yunia NASUNO, Saitama (JP)

(73) Assignee: HONDA MOTOR CO., LTD., Tokyo (JP)

(21) Appl. No.: 16/281,474

(22) Filed: Feb. 21, 2019

(30) Foreign Application Priority Data
Feb. 22, 2018 (JP) 2018-030141

(51) Int. Cl. H02K 3/12; H02K 1/16; H02K 3/48

(52) U.S. Cl. CPC H02K 3/12; H02K 3/48; H02K 1/16

(57) ABSTRACT

A stator of an electric rotary machine includes: a stator core; and a coil including a plurality of coil segments inserted into each of plural slots formed in the stator core. Among the plurality of coil segments inserted into each slot, coil segments positioned on an inner diameter side are Litz wires, and the other coil segments are solid wires.

### CROSS-REFERENCE TO RELATED APPLICATIONS

This application is based on and claims priority under 35 USC 119 from Japanese Patent Application No. 2018-030141 filed on Feb. 22, 2018, the contents of which are incorporated herein by reference.

### TECHNICAL FIELD

The present invention relates to a stator of an electric rotary machine to be mounted on an electric vehicle or the like,

### BACKGROUND ART

A stator of an electric rotary machine includes a stator core and a coil attached to the stator core. Recently, a so-called segmented conductor type electric rotary machine is known in which a coil loop is formed as the coil by joining a plurality of coil segments (for example, Japanese Patent Application Laid-Open Publication No. 2014-225974). In the electric rotary machine described in Japanese Patent Application Laid-Open Publication No. 2014-225974, the coil segment groups obtained by collectively stranding a plurality of approximately U-shaped coil segments are sequentially inserted from one end side of the stator core into the slots, the leg parts which project from the other end side of the stator core are bent, and the same-phase coils are joined together.

Such a segmented conductor type has a high coil space factor and extremely excellent performance. However, in the electric rotary machine which is used in high-speed rotation (high frequency), the segmented conductor type has a problem that the eddy current loss is larger compared to a coil using a bundle wire in the related art.

The eddy current loss is greatly affected by the frequency and the amount of leakage flux. The leakage flux acts most strongly on the inner-diameter-side portion (a portion near the rotor) of the coil. Thus, there are proposed a stator (for example, refer to Japanese Patent Application Laid-Open Publication No. 2011-147312.) in which a bundle wire is used in the inner-diameter-side portion of the coil, and a coil segment is used in the other portions (outer-diameter-side portion) or a stator (for example, refer to Japanese Patent No. 5331160) in which the position of the coil is far from the rotor to reduce the effect of the leakage flux.

Further, it has been attempted to reduce the eddy current loss itself, for example, by forming the coil with a subdivided conductor so-called a litz wire as a measure (for example, refer to Japanese Patent Application Laid-Open Publication No. 2006-100077 and. Japanese Patent Application Laid-Open Publication No. 2009-199749).

However, in the stator of Japanese Patent Application Laid-Open Publication No. 2011-147312, the bundle wire and the coil segment exist together, and the manufacturing method becomes complex and expensive. In addition, circulation loss occurs in the bundle wire which is an aggregate of thin wires. Thus, there is room for improvement in the reduction of the eddy current loss.

In addition, in the stator of Japanese Patent No. 5331160, the coil is relatively close to the outer diameter side. Thus, a back yoke is narrowed.

When all the segment coils are configured by the litz wire described in Japanese Patent Application Laid-Open Publication No. 2006-100077 and Japanese Patent Application Laid-Open Publication No. 2009-199749, the handleability deteriorates, and the cost is increased compared to a single-wire conductor. As for the stator of the electric rotary machine, it is required to have the advantage of the segmented conductor type and be capable of reducing the eddy current loss.

The invention provides a stator of a segmented conductor type electric rotary machine capable of reducing eddy current loss.

### SUMMARY OF INVENTION

A stator of an electric rotary machine related to the invention includes: a stator core; and a coil including a plurality of coil segments inserted into each of plural slots formed in the stator core. Among the plurality of coil segments inserted into each slot, coil segments positioned on an inner diameter side are litz wires, and the other coil segments are solid wires.

According to the invention, an eddy current is easily generated in the coil segment positioned on the inner diameter side among the plurality of coil segments inserted into respective slots. Thus, the eddy current loss can be reduced by forming the coil segment positioned on the inner diameter side with the litz wire.

### BRIEF DESCRIPTION OF DRAWINGS

FIG. 1 is a perspective view of a stator of an electric rotary machine of one embodiment of the invention;

FIG. 2 is a sectional view taken along line A-A of FIG. 1;

FIG. 3 is a sectional view taken along line B-B of FIG. 2;

FIG. 4A is a sectional view illustrating a configuration of a solid wire;

FIG. 4B is a sectional view illustrating a configuration of a litz wire;

FIG. 5A is a perspective view of a first coil segment in the stator illustrated in FIG. 1;

FIG. 5B is a perspective view of a second coil segment in the stator illustrated in

FIG. 6 is a developed view illustrating a state where parts of the stator illustrated in FIG. 1 are developed along a circumferential direction; and

FIG. 7 is a perspective view illustrating a state where end parts of the first coil segment and the second coil segment in the stator illustrated in FIG. 1 are joined to each other.

### DETAILED DESCRIPTION

Hereinafter, one embodiment of a stator of an electric rotary machine of the invention will be described with reference to the accompanying drawings. Incidentally, in the drawings, reference numeral RD indicates a radial direction of the stator, reference numeral AD indicates an axial direction of the stator, and reference numeral CD indicates a circumferential direction of the stator.

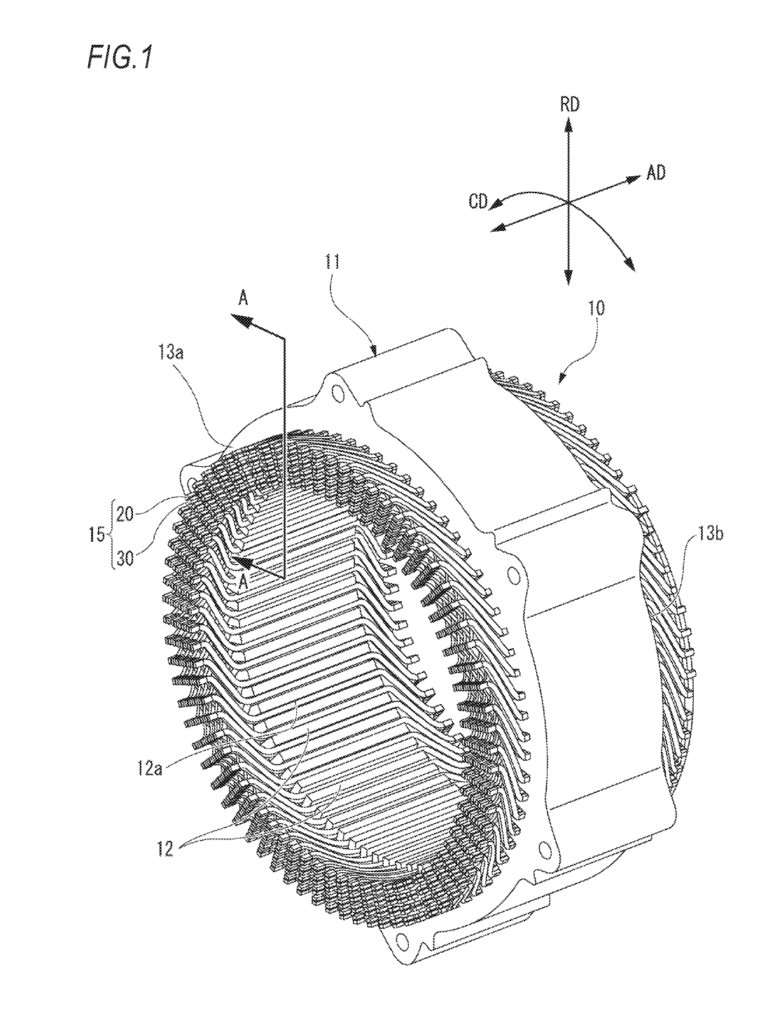

As illustrated in FIGS. 1 to 3, a stator 10 of an electric rotary machine includes a stator core 11 and a coil 15.

For example, the stator core 11 is an annular member formed by laminating a plurality of annular electromagnetic steel plates. The stator core 11 includes a plurality of slots 12 which are arranged at equal intervals along the circumferential direction CD of the stator core 11 in the inner circumferential surface thereof.

The slot 12 is formed as a groove which extends from one end surface 13a of the axial direction AD of the stator core 11 to the other end surface 13b of the axial direction AD of the stator core 11, and an opening part 12a is open on the inner circumferential surface of the stator core 11.

The coil 15 includes a plurality of coil segments which are inserted into each of the plural slots 12 formed in the stator core 11 and project from the slots 12 to the outside in the axial direction AD of the stator core 11.

The plurality of coil segments include a plurality of first coil segments 20 and a plurality of second coil segments 30.

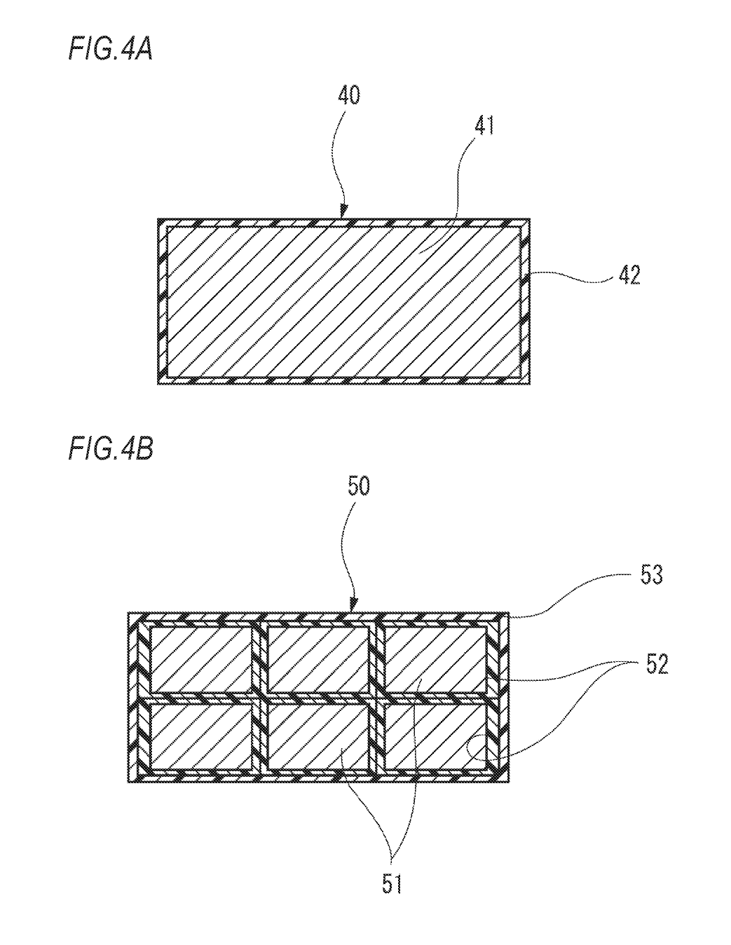

The first coil segment 20 includes a first solid-wire coil segment 20A, in which a solid wire 40 (flat wire) formed by covering a wire 41 having a substantially rectangular cross section with an insulating film 42 is formed in a substantially crank shape as illustrated in FIG. 4A, and a first litz-wire coil segment 20B, in which a litz wire 50 formed by stranding wires 51 which have a substantially rectangular cross section and are covered with insulating films 52 and further covering the wires with an insulating film 53 is formed in a substantially crank shape as illustrated in FIG. 4B.

The second coil segment 30 includes a second solid-wire coil segment 30A, in which the solid wire 40 (flat wire) formed by covering the wire 41 having a substantially rectangular cross section with the insulating film 42 is formed in a substantially crank shape as illustrated in FIG. 4A and a second litz-wire coil segment 30B, in which the litz wire 50 formed by stranding the wires 51 which have the substantially rectangular cross section and are covered with the insulating films 52 and further covering the wires with the insulating film 53 is formed in a substantially crank shape as illustrated in Fig, 4B.

The solid-wire coil segments 20A and 30A and the litz-wire coil segments 20B and 30B have the same shape (rectangular shape) and have substantially the same cross-sectional area. In addition, a circumferential width W is larger than a radial width H in the cross section. The litz wire effectively acts on the reduction of the eddy current loss generated in the coil 15 compared to the solid wire which is not subdivided and has the same cross-sectional area. In the conductor, when the frequency is high, the current flows biasedly to the surface of the conductor. However, the eddy current loss can be reduced by subdividing the conductor as the litz wire (a wire obtained by collecting a plurality of wires). In addition, in the litz wire, by stranding the wires 51, the potential difference induced in the wires 51 is offset by the transition effect. Thus, the circulation loss can be reduced.

As illustrated in Fig, 4B, the litz wire 50 of this embodiment is formed to have the substantially rectangular cross section by collecting six wires 51 having a rectangular cross section. Each of the wires 51 is insulated by the insulating film 52. The insulating film 53 covers the wires 51 covered with the insulating films 52 all together. Since the insulating films 52 and 53 cause the reduction in the space foctor, it is desirable to be thin by the extent in which the eddy current can be divided.

Incidentally, in the following description, in a case where it is not necessary to distinguish the first solid-wire coil segment 20A and the first litz-wire coil segment 20B, the coil segments are described as the first coil segment 20, and in a case where it is not necessary to distinguish the second solid-wire coil segment 304 and the second litz-wire coil segment 309, the coil segments are described as the second coil segment 30.

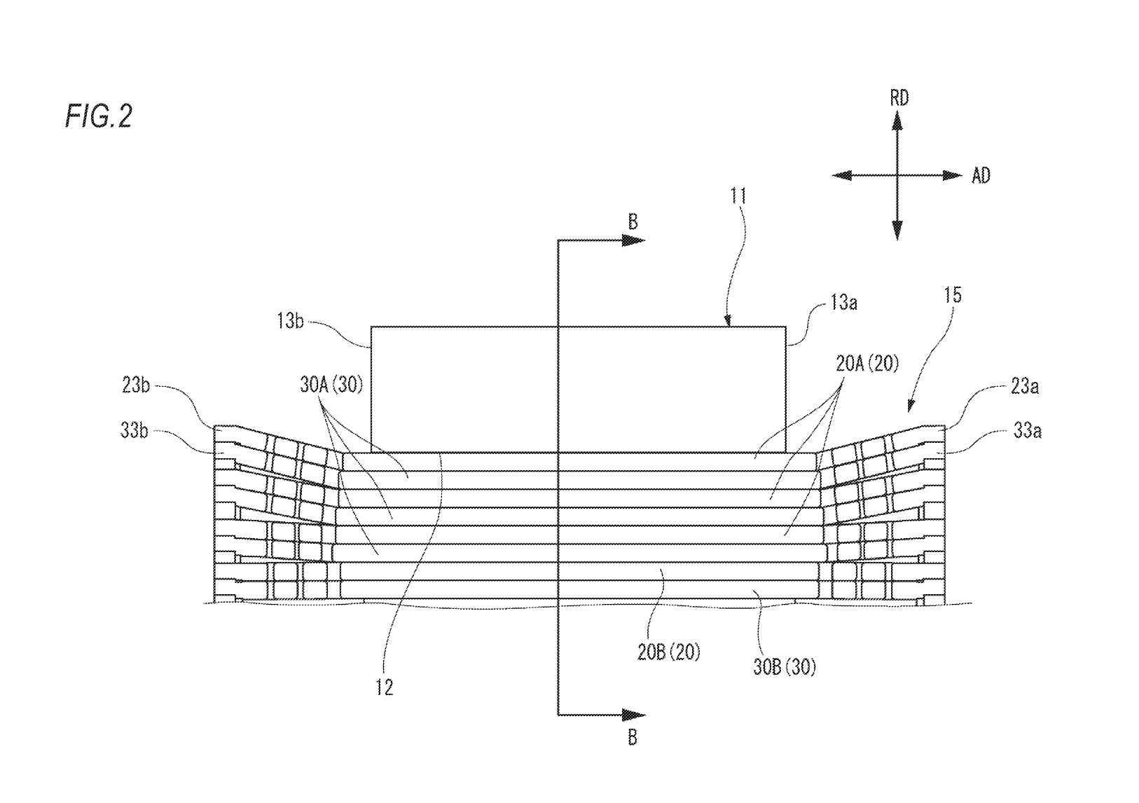

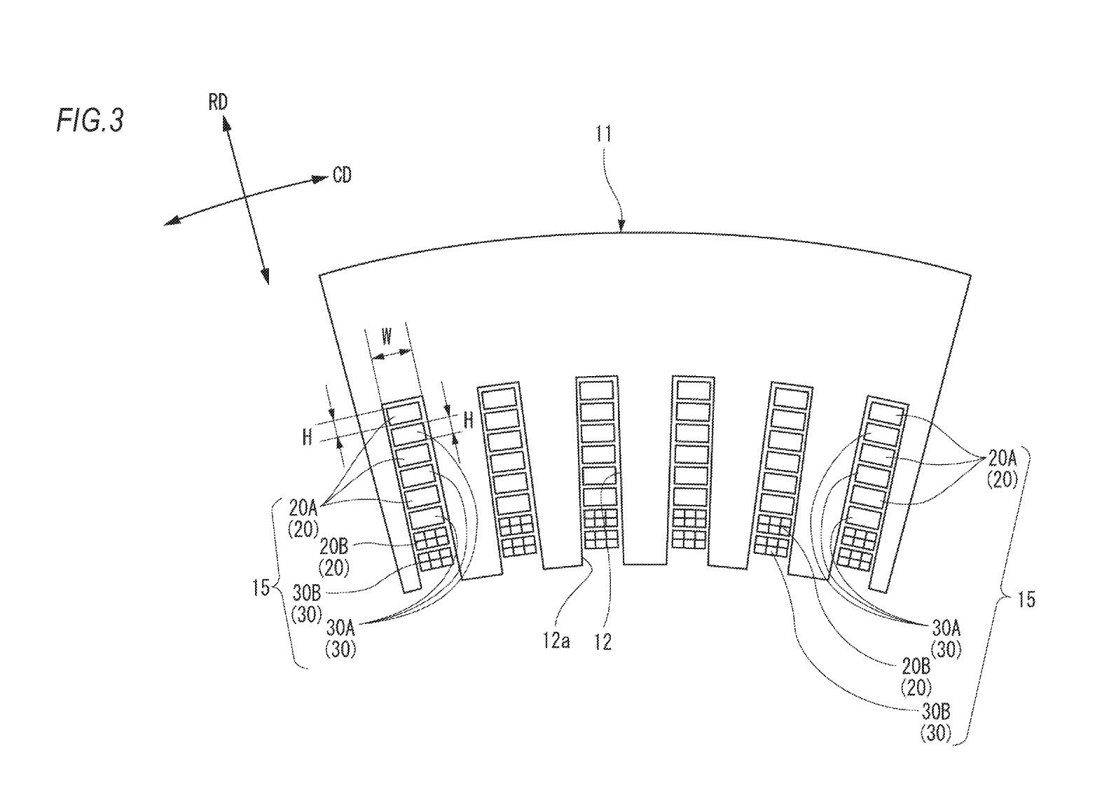

As illustrated in FIGS. 2 and 3, total six solid-wire coil segments of three first solid-wire coil segments 20A and three second solid-wire coil segments 30A are alternately inserted from the outer diameter side of each slot 12 of the stator core 11.

Total two litz-wire coil segments of one first litz-wire coil segment 20B and one second litz-wire coil segment 30B are alternately inserted from the outer diameter side on the radial inner side of three sets of coil segments including the first solid-wire coil segment 20A and the second solid-wire coil segment 30A.

Accordingly, in each slot 12 of the stator core 11, three sets of coil segments including the first solid-wire coil segment 20A and the second solid-wire coil segment 30A and one set of coil segments including the first litz-wire coil segment 20B and the second litz-wire coil segment 30B are inserted from the outer diameter side.

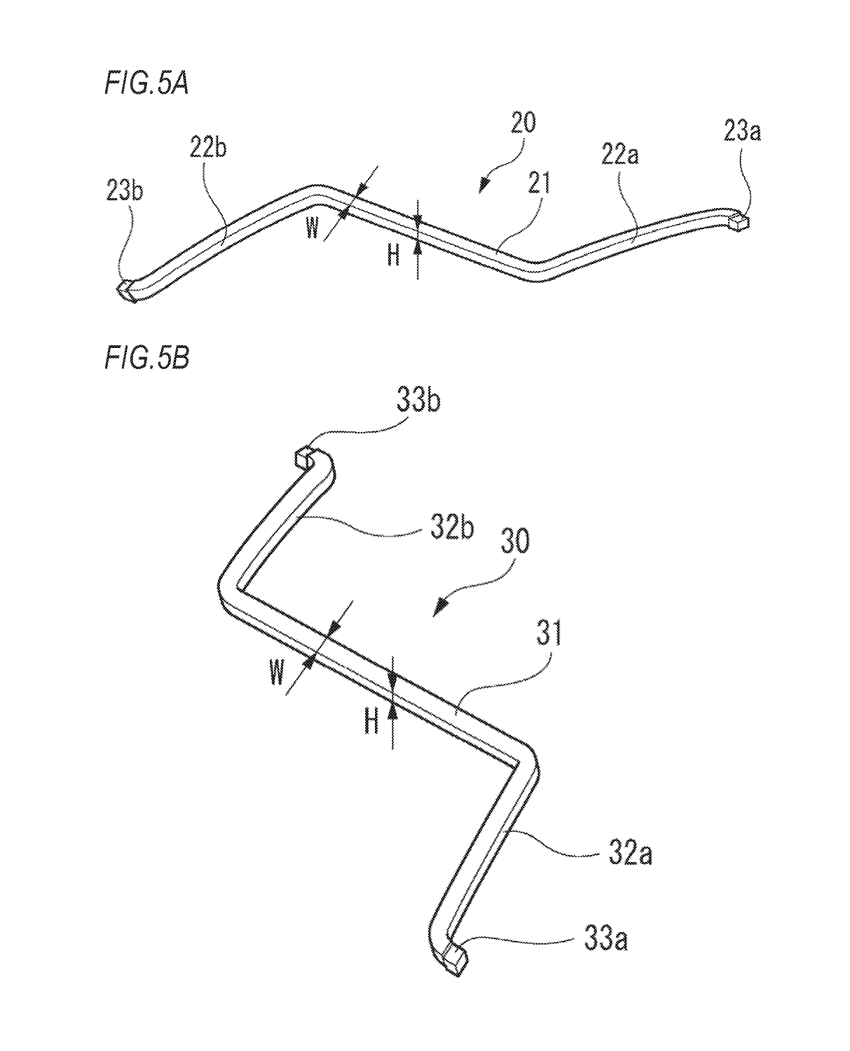

As illustrated in FIG. 5A, the first coil segment 20 includes a linear insertion part 21 inserted into the slot 12, a first projection part 22a which projects from one end of the insertion part 21 to the outside of the end surface 13a of the stator core 11 in the axial direction AD of the stator core 11 and a second projection part 22b which projects from the other end of the insertion part 21 to the outside of the end surface 13b of the stator core 11 in the axial direction.

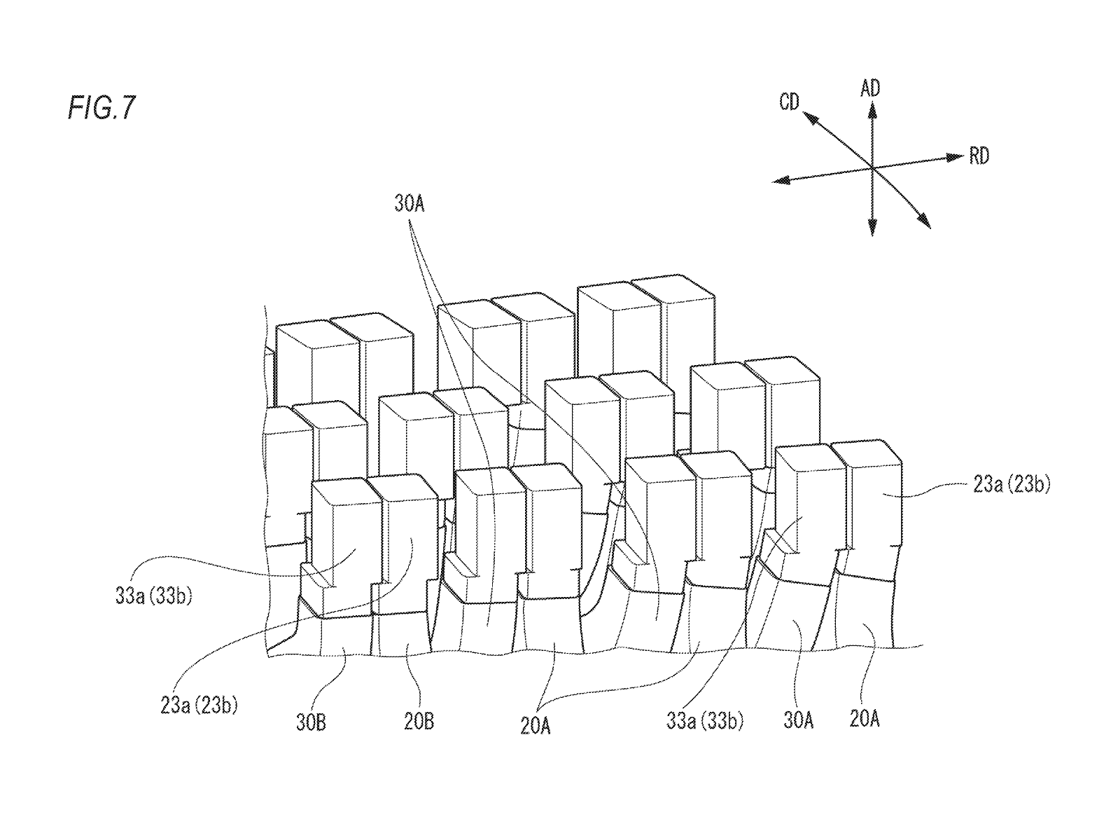

An end part 23a of the first projection part 22a is bent in a direction intersecting with the extending direction of the first projection part 22a to be substantially parallel to the insertion part 21. The end part 23a of the first projection part 22a is formed in a stepped shape in which the end part is formed to be offset toward the radially outside the stator core 11 through press forming (see FIG. 7).

An end part 23b of the second projection part 22b is bent in a direction intersecting with the extending direction of the second projection part 22b to be substantially parallel to the insertion part 21. Similarly to the end part 23a of the first projection part 22a, the end part 23b of the second projection part 22b is formed in a stepped shape in which the end part is formed to be offset toward the radially outside the stator core 11 through press forming (see FIG. 7).

As illustrated in FIG. 5B, the second coil segment 30 includes an insertion part 31 inserted into the slot 12, a first projection part 32a which projects to the outside in the axial direction AD of the stator core 11 compared to the end surface 13a of the stator core 11, and a second projection part 32b which projects to the outside in the axial direction AD compared to the end surface 13b of the stator core 11.

An end part 33a of the first projection part 32a is bent in a direction intersecting with the extending direction of the first projection part 32a to be substantially parallel to the insertion part 31. The end part 33a of the first projection part 32a, is formed in a stepped shape in which the end part is formed to be offset toward the radially outside the stator core 11 through press forming (see FIG. 7).

An end part 33b of the second projection part 32b is bent in a direction intersecting with the extending direction of the second projection part 32b to be substantially parallel to the insertion part 31. Similarly to the end part 33a of the first projection part 32a, the end part 33b of the second projection part 32b is formed in a stepped shape in which the end part is formed to be offset toward the radially outside the stator core 11 through press forming (see FIG. 7).

The first coil segment 20 and the second coil segment 30 are subjected to bending in a substantially crank shape in advance, and the bending angle (for example, 100° to 130°) thereof is gentle. Thus, it is prevented that the insulating films 52 and 53 are damaged during forming even in the litz-wire coil segments 20B and 30B.

As in the electric rotary machine of the related art described in Japanese Patent Application Laid-Open Publication No. 2014-225974, when the litz-wire coil segment is used in a U-shaped coil segment, the insulating film is damaged during forming of the U shape or during twisting. Furthermore, the insulating film is necessarily thickened in order to prevent the insulating film from being damaged, resulting in deterioration in the space factor. In this embodiment, since the first coil segment 20 and the second coil segment 30 are used which are bent in a crank shape, it is possible to suppress a load on the insulating film during bending, thereby preventing the damage of the insulating film without thickening the insulating film.

The first coil segment 20 and the second coil segment 30 formed as described above are assembled to the stator core 11 in the state of being formed in a predetermined shape, that is, a crank shape in advance by inserting the linear insertion parts 21 and 31 from the opening part 12a formed on the inner diameter side of the slot 12. Since the linear insertion parts 21 and 31 are inserted from the opening part 12a, the damage to the insulating films 52 and 53 due to the assembling is prevented. In addition, after the insertion, since the first coil segment 20 and the second coil segment 30 do not need to be subjected to bending (secondarily forming), the manufacturing is facilitated.

Since the first coil segment 20 and the second coil segment 30 are easily assembled to the stator core 11 and can be inserted into an arbitrary slot 12 independently one by one, only a coil at a specific position in the slot 12 can be formed of the litz-wire coil segments 20B and 30B. That is, in the electric rotary machine of the related art described in Japanese Patent Application Laid-Open Publication No. 2014-225974, one leg pail and the other leg part of the U-shaped coil segment have different positions in the slot. Thus, it is not possible to form only a coil at a specific position as the litz wire.

According to this embodiment, only the coil at a specific position can be formed with the litz wire. Thus, it is possible to form one set of the first coil segment 20 and the second coil segment 30 in the most effective innermost diameter portion as the litz-wire coil segments 20B and 30B. Accordingly, it is possible to suppress an increase of the manufacturing cost and minimize the deterioration in the space factor caused by the use of the litz-wire coil segments 20B and 30B. Incidentally, only the first layer on the innermost diameter side may be formed of the litz-wire coil segment, and the coil segments of the first layer to the third layer or the first layer to the fourth layer from the innermost diameter side may be formed of the litz-wire coil segment. The optimum arrangement can be selected according to the specification.

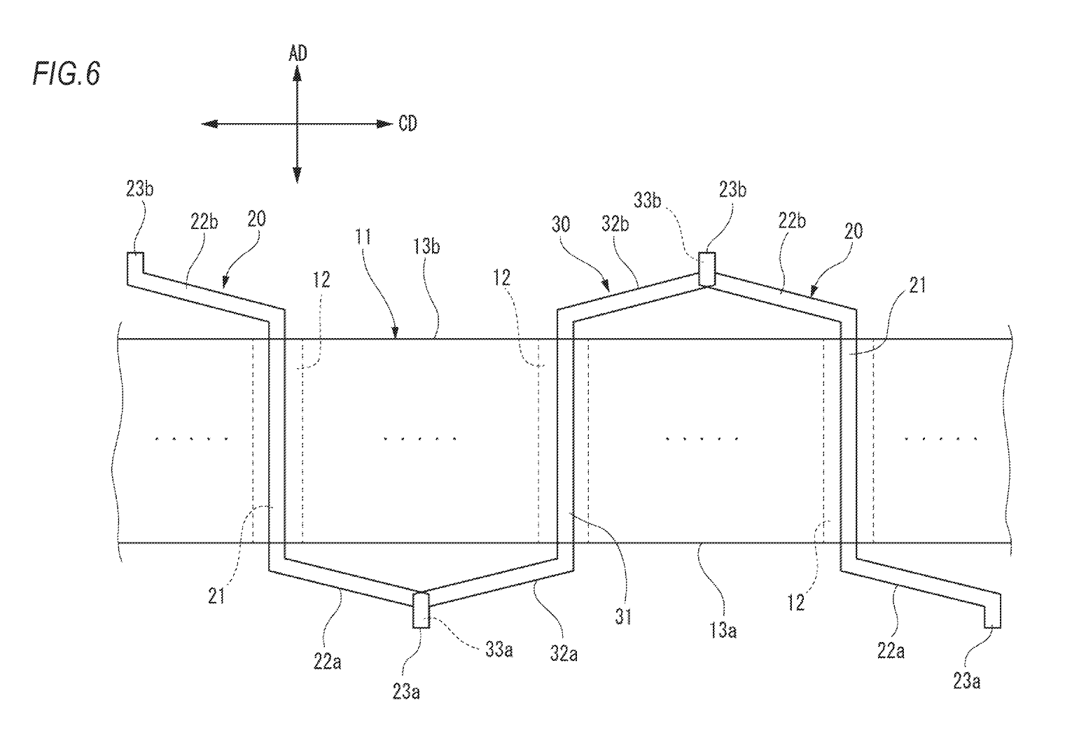

As illustrated in FIG. 6, the first projection part 22a of the first coil segment 20 of which the insertion part 21 is inserted into the slot 12 extends along the circumferential direction CD of the stator core 11 toward the right direction. The second projection part 22b extends along the circumferential direction CD of the stator core 11 toward the direction (left direction) opposite to the first projection part 22a.

Similarly, the first projection part 32a of the second coil segment 30 of which the insertion part 31 is inserted into the slot 12 extends along the circumferential direction CD of the stator core 11 toward the left direction. The second projection part 32b extends along the circumferential direction CD of the stator core 11 toward the direction (right direction) opposite to the first projection part 32a.

In FIG. 6, as for the coil 15, only one second coil segment 30 and two first coil segments 20 electrically connected to the second coil segment 30 are extracted and illustrated for facilitating understanding.

The end part 23a of the first coil segment 20 is joined with the end part 33a of the second coil segment 30 which is inserted into another slot 12 at a position (the position moving clockwise when viewed from the end surface 13a side) separated in one direction along the circumferential direction CD of the stator core 11 from the slot 12 (hereinafter, also referred to as the insertion slot) into which the first coil segment 20 is inserted. Incidentally, the joining indicates that the insulating films (the insulating films 42, 52, and 53 of this embodiment) covering the conductor are melted and the conductors are electrically connected to each other (the solid wires 40 are connected to each other and the litz wires 50 are connected to each other in this embodiment).

The end part 23b of the first coil segment 20 is joined with the end part 33b of the second coil segment 30 inserted into still another slot 12 at a position (the position moving counterclockwise when viewed from the end surface 13a) separated from the insertion slot in the other direction along the circumferential direction CD of the stator core 11.

In this way, a coil loop is formed by repeating the joining between the end part 23a of the first coil segment 20 and the end part 33a of the second coil segment 30 and the joining between the end part 23b of the first coil segment 20 and the end part 33h of the second coil segment 30.

The coil loop formed on the outer diameter side of each slot 12 is formed of the first solid-wire coil segment 20A and the second solid-wire coil segment 30A. The coil loop formed on the inner diameter side of the first solid-wire coil segment 20A and the second solid-wire coil segment 30A is formed of the first litz-wire coil segment 20B and the second litz-wire coil segment 30B.

The coil 15 includes the plurality of coil loops, and the plurality of coil loops are selectively connected to one another, thereby forming a power line of plural phases (such as a U phase, a V phase, and a W phase).

As illustrated in FIG. 7, the end part 23a of the first coil segment 20 is joined with the end part 33a through laser welding or tungsten inert gas (TIG) welding in the state of abutting to the end part 33a of the second coil segment 30.

The eddy current loss of the first and second coil segments 20 and 30 is generated when the leakage flux from the rotor side (not illustrated) or the leakage flux from the teeth tip enters the opening part 12a of the slot 12. Thus, the eddy current loss is prominently generated in the coil segment on the inner diameter side of the stator 10.

Accordingly, the eddy current loss can be reduced effectively by forming the coil segments on the inner diameter side with the first litz-wire coil segment 20B and the second litz-wire coil segment 30B as described above.

Incidentally, the above-described embodiment may be modified or improved appropriately. For example, in the above-described embodiment, the first coil segment 20 and the second coil segment 30 are formed in a crank shape. However, the invention is not limited thereto, and the first coil segment and the second coil segment may be formed in an arbitrary shape such as an S shape.

At least the following items are described in this specification, Incidentally, in the parentheses, the corresponding components or the like in the above-described embodiment are presented, but the invention is not limited thereto.

(1) A stator (a stator 10 of an electric rotary machine) of an electric rotary machine comprising:

a stator core (a stator core 11); and

a coil (a coil 15) including a plurality of coil segments (a first coil segment 20 and a second coil segment 30) to be inserted into each of plural slots (slots 12) formed in the stator core, wherein

among the plurality of coil segments inserted into each slot, coil segments (a first litz-wire coil segment 20B and a second litz-wire coil segment 30B) positioned on an inner diameter side are litz wires (litz wires 50), and the other coil segments (a first solid-wire coil segment 20A and a second solid-wire coil segment 30A) are solid wires.

According to (1), in the coil segment positioned on the inner diameter side among the plurality of coil segments inserted into each slot, the eddy current is generated easily. However, the eddy current loss can be reduced by forming the coil segment positioned on the inner diameter side as the litz wire. That is, according to (1), the eddy current loss which is a defect of the segmented conductor type electric rotary machine can be reduced while taking an advantage thereof that the space factor is high and the manufacturing is facilitated.

(2) The stator of the electric rotary machine according to (1), wherein

the plurality of coil segments include at least a set of plural first coil segments first coil segments 20) and plural second coil segments (second coil segments 30),

the first coil segment includes an insertion part (an insertion part 21) inserted into the slot, a first projection part (a first projection part 22a) projecting to an outside in an axial direction compared to one end surface of the stator core in the axial direction, and a second projection part (a second projection part 22b) projecting to the outside in the axial direction compared to the other end surface of the stator core in the axial direction,

the second coil segment includes an insertion part (an insertion part 31) inserted into the slot, a first projection part (a first projection part 32a) projecting to the outside in the axial direction compared to the one end surface of the stator core in the axial direction, and a second projection part (second projection part 32b) projecting to the outside in the axial direction compared to the other end surface of the stator core in the axial direction,

an end part (an end part 23a) of the first projection part of the first coil segment abuts to an end part (an end part 33a) of the first projection part of the second coil segment to be joined with each other, and

an end part (an end part 23b) of the second projection part of the first coil segment abuts to an end part (an end part 33b) of the second projection part of the second coil segment to be joined with each other.

According to (2), only the coil segment positioned on the inner diameter side can be formed with the litz wire using an independent coil segment joining both ends of one coil segment.

(3) The stator of the electric rotary machine according to (2), wherein the plurality of coil segments include a plurality sets of the plural first coil segments and the plural second coil segments, and

among the plurality of coil segments inserted into each slot, the first coil segment and the second coil segment which are included in one set positioned on the innermost diameter side are the litz wires, and the first coil segments and the second oil segments which are included in the other sets of are the solid wires.

According to (3), since one set of the first coil segment and the second coil segment in which the eddy current is generated most easily and which are positioned on the innermost diameter side are formed with the litz wire, the manufacturing cost can be reduced and the eddy current loss can be reduced.

(4) The stator of the electric rotary machine according to any one of (1) to (3), wherein

an opening part (an opening part 12a) of each slot is provided in an inner circumferential surface of the stator core, and

the plurality of coil segments are inserted from the opening part of each the plural slots.

According to (4), assemblability is excellent, and the damage of the insulating film of the coil segment is prevented.

(5) The stator of the electric rotary machine according to (4), wherein

the plurality of coil segments are processed into a substantially crank shape in advance and are inserted from the opening part of each of the plural slots.

According to (5), since the plurality of coil segments are processed into the substantially crank shape in advance and are inserted from each opening part of the plural slots, the bending processing or the like is not necessarily performed on the plural coil segments after the coil segments are inserted into the slot, thereby preventing the scattering of the litz wire or the like.

(6) The stator of the electric rotary machine according to any one of (1) to (5), wherein

the litz wire is an aggregate of wires (wires 51) which are insulated with an insulating film (an insulating film 52) and have rectangular cross sections, and

the litz wire and the solid wire have substantially the same shape.

According to (6), since the litz wire is the aggregate of the wires, which are insulated with the insulating film and have the rectangular cross sections, and has substantially the same shape as the solid wire, the space factor of the coil in the slot can be improved.

What is claimed is:

1. A stator of an electric rotary machine comprising:
a stator core: and
a coil including a plurality of coil segments inserted into each of plural slots formed in the stator core, wherein
among the plurality of coil segments inserted into each slot, coil segments positioned on an inner diameter side are litz wires, and the other coil segments are solid wires.

2. The stator of the electric rotary machine according to claim 1, wherein
the plurality of coil segments include at least a set of plural first coil segments and plural second coil segments,
the first coil segment includes an insertion part inserted into the slot, a first projection part projecting to an outside in an axial direction compared to one end surface of the stator core in the axial direction, and a second projection part projecting to the outside in the axial direction compared to the other end surface of the stator core in the axial direction,
the second coil segment includes an insertion part inserted into the slot, a first projection part projecting to the outside in the axial direction compared to the one end surface of the stator core in the axial direction, and a second projection part projecting to the outside in the axial direction compared to the other end surface of the stator core in the axial direction,
an end part of the first projection part of the first coil segment abuts to an end part of the first projection part of the second coil segment to be joined with each other, and
an end part of the second projection part of the first coil segment abuts to an end part of the second projection part of the second coil segment to be joined with each other.

3. The stator of the electric rotary machine according to claim 2, wherein
the plurality of coil segments include a plurality sets of the plural first coil segments and the plural second coil segments, and
among the plurality of coil segments inserted into each slot, the first coil segment and the second coil segment which are included in one set positioned on the innermost diameter side are the litz wires, and the first coil segments and the second oil segments which are included in the other sets are the solid wires.

4. The stator of the electric rotary machine according to claim I, wherein
an opening part of each slot is provided in an inner circumferential surface of the stator core, and
the plurality of coil segments are inserted from the opening part of each of the plural slots.

5. The stator of the electric rotary machine according to claim 4, wherein
the plurality of coil segments are processed into a substantially crank shape in advance and are inserted from the opening part of each of the plural slots.

6. The stator of the electric rotary machine according to claim 1, wherein
the litz wire is an aggregate of wires which are insulated with an insulating film and have rectangular cross sections, and
the litz wire and the solid wire have substantially the same shape.
